(19) United States
(12) Patent Application Publication
(10) Pub. No.: US 2012/0084118 A1
(43) Pub. Date: Apr. 5, 2012

(54) SALES PREDICATION FOR A NEW STORE BASED ON ON-SITE MARKET SURVEY DATA AND HIGH RESOLUTION GEOGRAPHICAL INFORMATION

(75) Inventors: Xin Xin Bai, Beijing (CN); Jin Dong, Beijing (CN); Ta-Hsin Li, Danbury, CT (US); Hai Rong Lv, Beijing (CN); Wen Jun Yin, Beijing (CN)

(73) Assignee: INTERNATIONAL BUSINESS MACHINES CORPORATION, Armonk, NY (US)

(21) Appl. No.: 12/894,880

(22) Filed: Sep. 30, 2010

(51) Int. Cl. G06Q 10/00

(52) U.S. Cl. 705/7.31

(57) ABSTRACT

A method for predicting sales for a new store in a certain geographical area is disclosed, the method comprising geographic and non-geographic information and customer segmentation in the area to estimate sales and optionally the impact on existing competitor stores.

### FIELD OF THE INVENTION

The present invention generally relates to predicting sales for convenience retail outlets including, without limitation, before such an outlet opens, or where historical sales data are otherwise unavailable.

### DESCRIPTION OF THE RELATED ART

Typical methods for forecasting sales are mostly directed to existing stores and utilize in-store historical sales data. For new stores, where historical data do not exist or are insufficient, predictive methods are often based on external surrounding data which can be used to provide a rough estimate of sales. Such external surrounding data include, for example, an estimate of market share for a given area where the new store will be located, and/or references to sales for similar stores' that already exist in the proximate geographical area.

For predicting sales of new stores where those stores have physical constraints on customer accessibility and/or customer preference, the high resolution of underlying data as normally would be relied upon otherwise, is often unobtainable. Hence, a predictive method of sales for such new stores is desirable.

### SUMMARY

The present invention employs both high and low resolution data to predict sales for a new store in a certain geographical area. The method is preferably computer-based, and segments customers in the certain geographic area into Geographically Distributed Customer Segments (GDCS) such as e.g. residents, shoppers and workers that are within the certain geographic area, and generates a Consumer Demand Estimation Module (CDEM). The CDEM provides an estimate of Unit Demand for each GDCS using sub-grids of the certain geographic area, with geographic and non-geographic data comprised of the following: a Store Accessibility Model, a Store Attractiveness Model, a Customer Preference Model, and a Demand Adjustment Factor. The estimate of Unit Demand is utilized by a Sales Prediction Module which predicts potential sales for the new store and optionally the influence of the new store on existing, competing stores.

### BRIEF DESCRIPTION OF THE DRAWINGS

FIG. 1 is a flow diagram illustrating an embodiment of the method of the present invention.

FIG. 2 is a diagram illustrating an embodiment of a Geographically Distributed Customer Segments (GDCS) useable in the present invention.

FIG. 3 is an illustration of an embodiment of the present invention whereby the GDCS data are stored in a type of Geographic Information System (GIS) platform.

FIG. 4 is an illustration of an aspect of an embodiment of the present invention whereby the certain geographical area is divided into sub-grids, some of which may contain a GDCS of FIG. 3.

FIG. 5 is an illustration of an aspect of an embodiment of an on-site customer survey in the context of the sub-grid of FIG. 4 useable in the present invention.

FIG. 6 is an illustration of an aspect of an embodiment of an Accessibility Model useable in the present invention.

FIG. 7 is a flow diagram illustrating aspects of an embodiment of an Attractiveness Model useable in the present invention.

FIG. 8 is a graph depicting an aspect of an embodiment of a Customer Preference Model useable in the present invention.

FIG. 9 illustrates an exemplary hardware configuration performing a method according to one embodiment.

### DETAILED DESCRIPTION OF AN EXEMPLARY EMBODIMENT OF THE INVENTION

As will be illustratively explained in an embodiment of the present invention as further detailed below, the present invention provides a technique for predicting the sales for a new store in a certain geographical area. Without limitation, a store in this regard includes a convenience retail outlet. Preferably, the new store is or will be located proximate major traffic points, including e.g. fast food restaurants, coffee shops, convenience stores, ATM machines, gas stations and the like as further preferably located near shopping malls, supermarkets, railway stations, office buildings, residential complexes, etc.

In a preferred embodiment as hereinbelow described, the present invention partitions a low resolution grid into high resolution sub-grids (i.e. geographical elements), classifies them into different customer classes (also known as occasions), and then applies accessibility and attractiveness scores to estimate the Unit Demand for each class using a known Geographical Information System (GIS). GIS's serviceable in the invention are those conventionally available that effectively merge cartographic and database technology and as a system has the general abilities to integrate, store, edit, analyze, share and display geographic information, with ability to create interactive queries, e.g. user-based searches, analyze spatial information, edit data, maps and present attending results.

The invention integrates data from stores already existing in the certain geographic area, preferably in-store data (e.g. on-site shopper surveys, existing store sales data and the like), and external data (e.g. geographic and non-geographic data, the latter including demographic data) to generate a Customer Demand Estimation Module which can then be applied to new stores via a Sales Prediction Module to predict potential sales for the new store.

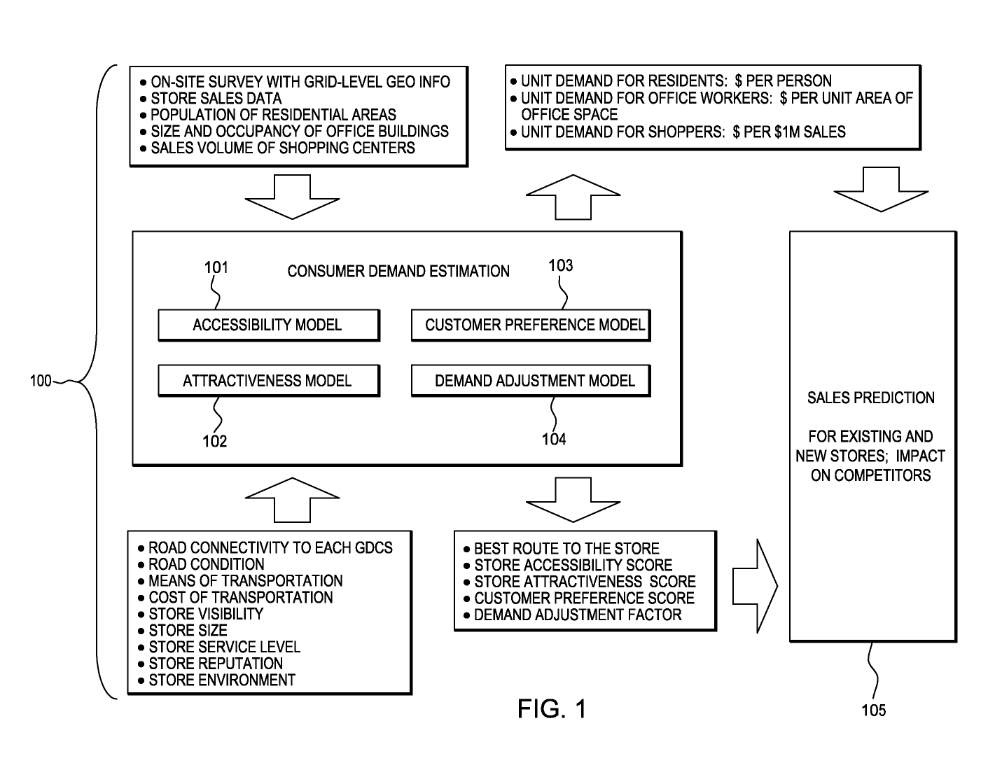

Once the certain geographic area for the new store is identified, non-geographic and geographic profile data are obtained from that area. As shown in FIG. 1, element 100, non-geographic data includes without limitation the population of residential areas in the certain geographical area, the size and occupancy of office buildings and other business operations in that certain geographic area, the number of shoppers and the sales data for existing stores and shopping centers (e.g. shopping malls) in the certain geographic area, and on-site surveys at the sub-gird level as described below.

Geographic data includes without limitation the road connectivity of each GDSC in the certain geographic area to the new store location (e.g. from each customer segment, such as various residences, places of work and shopping centers to the new store), the conditions of the roads, the means of transportation, the cost of transportation, the visibility of the new store, the size of the new store, the reputation of existing stores in the area, the service level of the existing stores in the area, the environment of existing stores in the area.

Turning to FIG. 1, the geographic and non-geographic data are used to create a Customer Demand Estimation Module, or CDEM. As shown in FIG. 1, the CDEM is comprised at least of an Accessibility Model (element 101), an Attractiveness Model (element 102), a Customer Preference Model (element 103) and a Demand Adjustment Factor (element 104). Output from the CDEM comprises among other things information related to competitiveness with existing stores in the certain geographical area, including scores for store accessibility, scores for store attractiveness, scores for customer preference, and a demand adjustment factor. The CDEM also provides an estimate of consumer demand, known herein as Unit Demand, among the various customer segments, i.e. for each GDSC. Unit Demand includes the dollar ($) amount or other currency or value potentially available for spending from each consumer class in the certain geographical area, e.g. Unit Demand can be expressed as $ per person for residents, $ per unit area of office space for workers, $ per $1 MM in sales for shoppers in the certain geographical area. As indicated in FIG. 1, this information emanating from the CDEM is provided to a Sales Prediction Module (element 105) which then predicts sales for a new store in the certain geographical area and optionally, the impact of the new store on existing competitor stores (also known as peer stores) in that area, e.g. sales that will be lost to those existing stores.

An embodiment for each Module and Model will now be described.

### Consumer Demand Estimation Module (CDEM):

A CDEM for purposes of the invention comprises geographic and non-geographic information with customer segmentation (into residents, shoppers, workers) in the certain geographical area within which the new store is or will be located, which information is then used to form an Accessibility Model, an Attractiveness Model, a Customer Preference Model, and a Demand Adjustment Factor. From these, the CDEM provides an estimate of Unit Demand in, for example, dollars ($) per person, ascribable to a particular segment of customers within that certain geographical area. The estimates for Unit Demand are then used in a Sales Prediction Module which predicts the potential sales for the new store in that certain geographical area, and optionally, predicts the impact of the new store's sales on competitor stores in that certain geographical area.

### Data Preparation:

In one aspect of the invention, both geographic profile and non-geographic profiles are integrated into a Geographic Information System (GIS) platform, as conventionally known and available, and analyzed together, FIG. 1, element 100.

Segmenting Customers within the Certain Geographical Area into Geographically Distributed Customer Segments (GDCS):

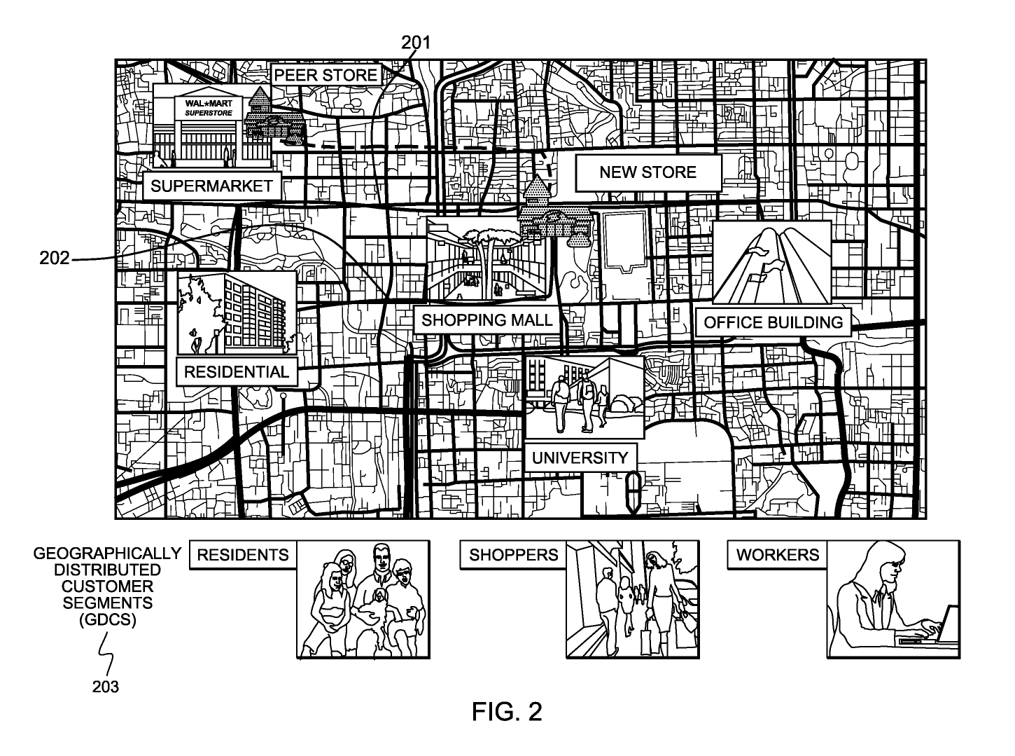

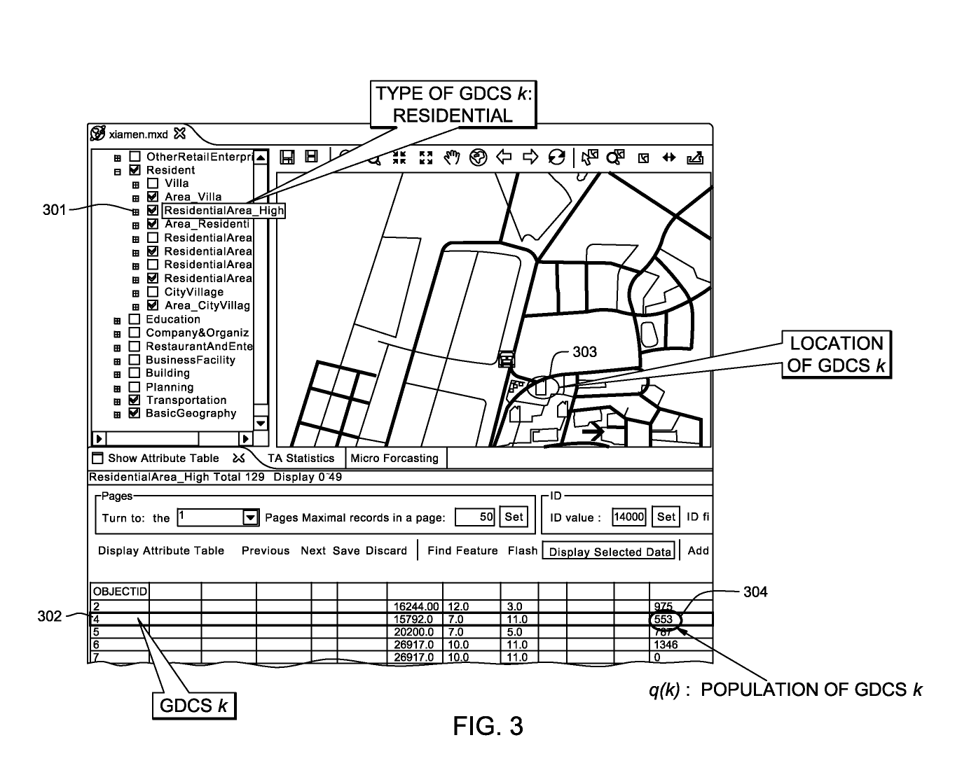

Customer segmentation is performed by Geographical Element Type, and is referred to herein as GDSC (see FIG. 2, element 203). There are several classes of GDCS, including without limitation: residents, shoppers, workers. The GDCS data are preferably stored in a GIS platform as known in the art. FIG. 3 illustrates an example of how the GDCS data are stored in GIS format. In FIG. 3, the k-th GDCS (element 302) is a residential area (element 301), the geo-coded point of GDCS k is located at element 303 (in FIG. 3) in the GIS map. The main attribute of GDCS k is its population q(k) denoted element 304 in FIG. 3, which will be employed in sales prediction.

### Onsite Survey Data:

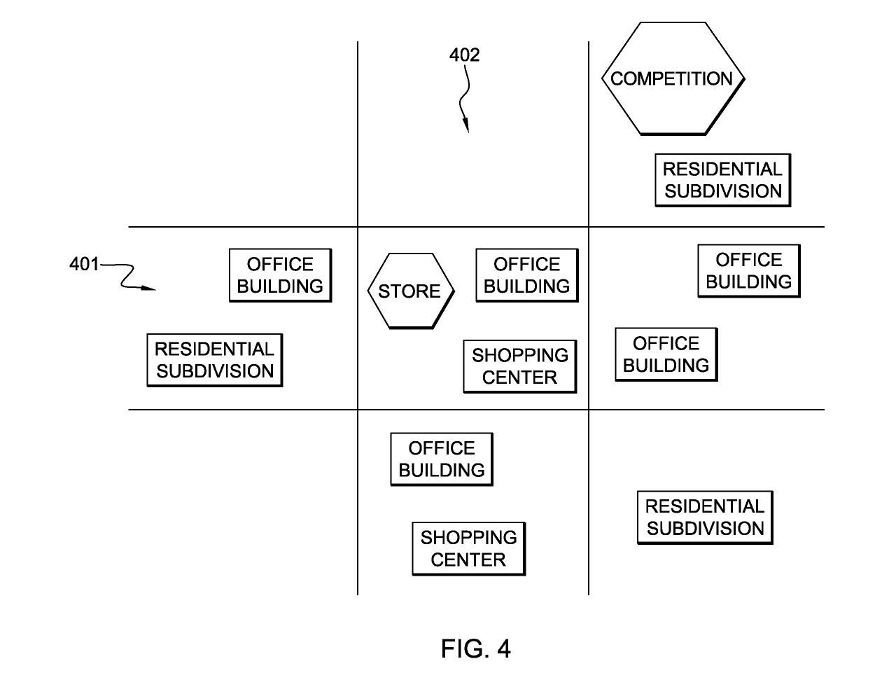

An on-site customer survey is performed by dividing the geographical areas into small grids, e.g. 200 m×200 m, as illustrated in FIG. 4. Some grids may contain several GDCSs (see FIG. 4, element 401) whereas other grids may contain nothing (see FIG. 4, element 402).

For a randomly selected customer who comes into the store to buy, the investigator will ask that customer some questions.

For example:

Question 1: which grid on the map are you from? (The investigator will show the customer a map of the geographical area divided into the grids as aforesaid).
Question 2: how much have you to spend in this store (The investigator will record the answer in a two-dimensional data table.)

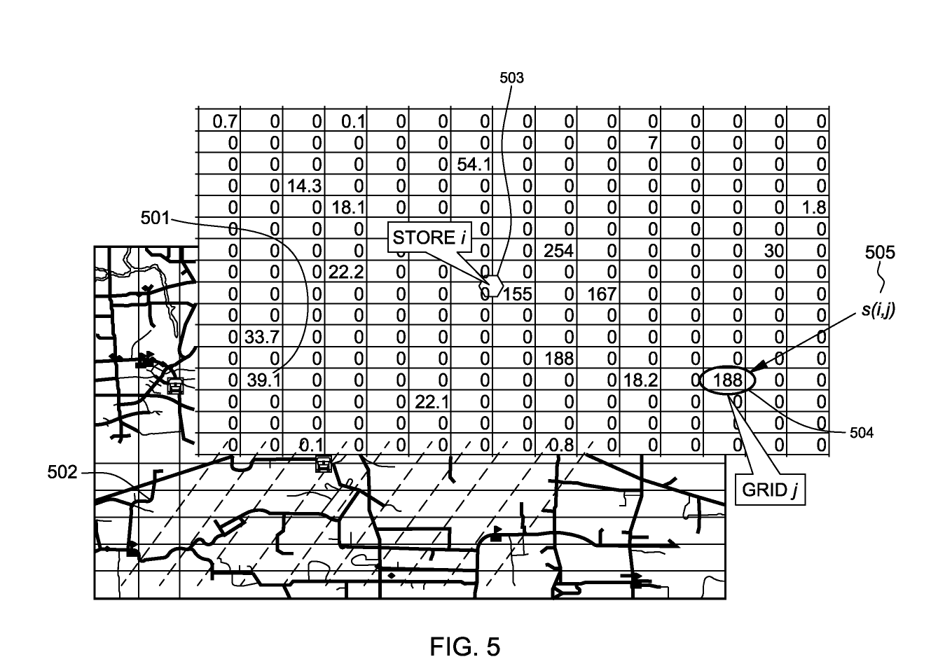

Thus, as shown in FIG. 5, if a customer says they are from a certain grid (element 502), then the corresponding data table element (element 501) will add up to how much the customer consumes.

This customer survey period will last for some period of time suitable to know the store's sales in this same period, and to know the relative proportion of each grid so that the sales contribution from each store i (element 503) to grid j (element 504): s(i,j) (element 505).

### 2. Accessibility Model (Element 101, FIG. 1)

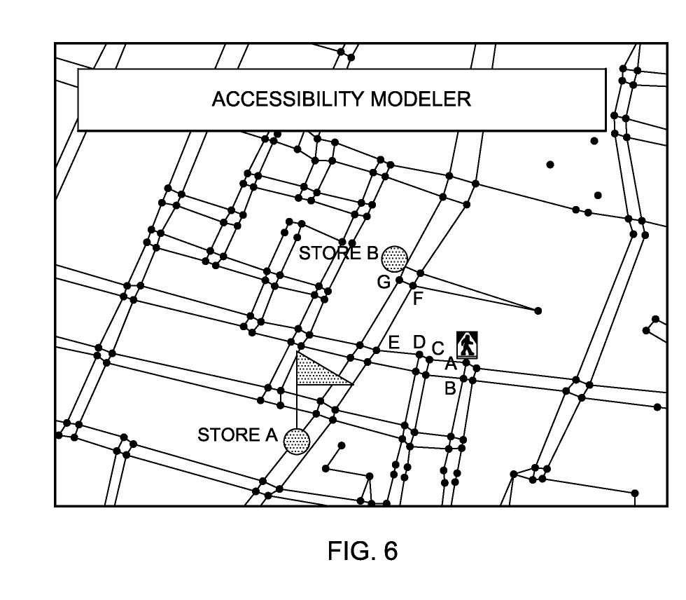

Turning to FIG. 2, in the usual course, there are multiple paths (elements 201, 202) from a particular GDCS (element 203, including residents, shopper, workers as shown in FIG. 2) to a store. As shown in FIG. 2, the location of a proposed New Store is depicted, along with nearby paths and GDCS's in the certain geographical area (The GDCS's shown in FIG. 2 as embodied in a supermarket and shopping mall; a residential apartment building; an office building; a university). The accessibility model (FIG. 6) represents the road connectivity to each GDCS, including factors such as road conditions, available means of transportation, cost of transportation, and the like.

For example:

Suppose there are M candidate paths from a GDCS to a store, and the i-th path is divided into Ki segments, wherein each segment has certain attributes, e.g. length (l), walking time (t). Thus:

pᵢ={ps_{i,1}(l_{i,1},t_{i,1}),ps_{i,2}(l_{i,2},t_{i,2}), . . . ,ps_{i,Ki}(l_{i,Ki},t_{i,Ki})}

Then the accessibility can be evaluated by:

a=min(Σt_{i,k})

iε{1,2 . . . M} k=1

### 3. Attractiveness Model (Element 102, FIG. 1)

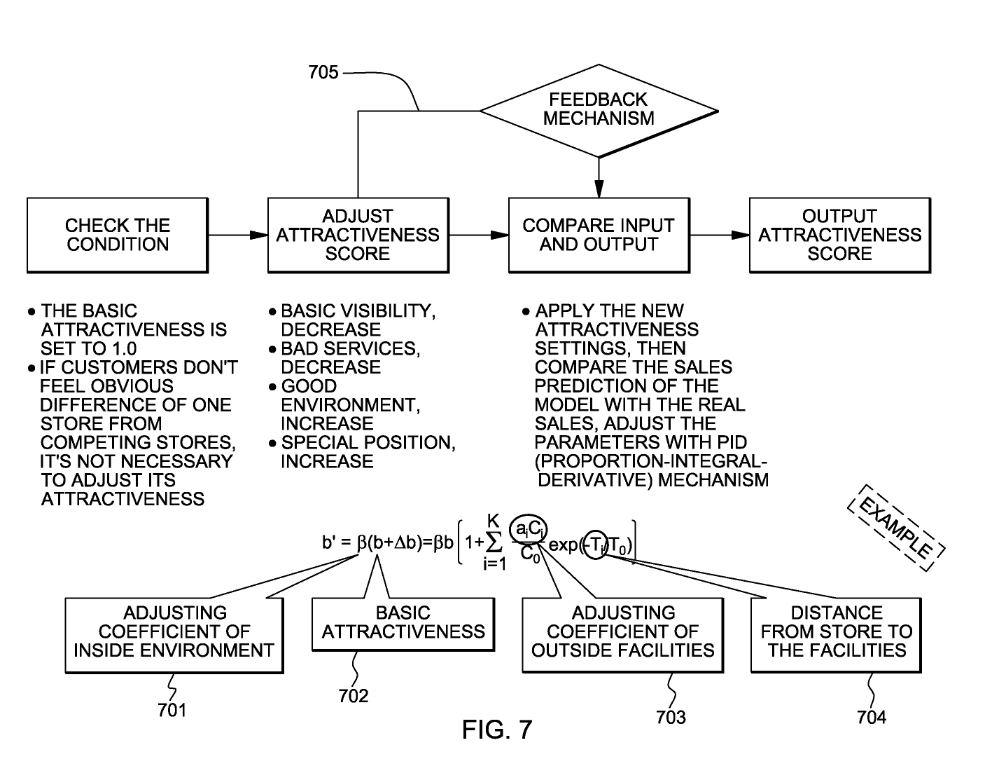

The attractiveness model is used to measure a store's ability to attract customers. A store's attractiveness can be set by people's experiences. In a preferred embodiment, a quantitative closed-loop feedback mechanism (see FIG. 7, element 705) is employed to adjust the store's attractiveness score based on multiple data sources, including without limitation, store sales, store attributes data (e.g. visibility, store size, service level, environment, long history, etc.), on-site shopper survey data (e.g. shopper's feedback on attractiveness, etc.):

$$b = β ( b + Δ b ) = β b \times ( 1 + {\sum }_{i - 1}^{k} \frac{{a}_{i} {C}_{i}}{{C}_{0}} exp ( - {T}_{i} / {T}_{o} )$$

The variables above are defined in FIG. 7, elements 701, 702, 703 and 704.

### 4. Customer Preference Model (Element 103, FIG. 1):

The customer preference model estimates the probability that a customer segment selects each competing store based on the difference in each store's attractiveness and accessibility scores. The customer preference can be computed by:

$$p = \frac{c}{c + \sum {C}_{competition}}$$

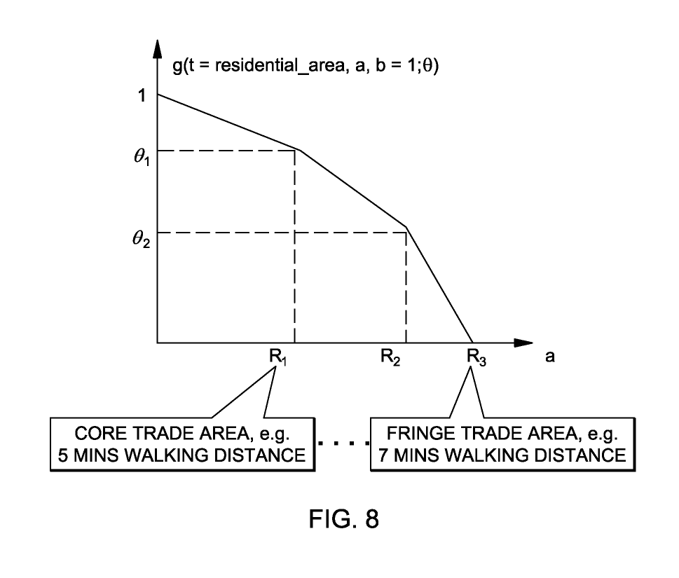

Here, c is a function to measure the composite score of a store and belong to [0,1]. We use g(t,a,b; θ) to represent c.
c=g(t,a,b; θ)=composite score, cε[0,1]
An example of g is as the following (also shown in FIG. 5);
g(t=residential, a,b=θ)
θ₁+(1−θ₁)(1−a/R₁) 0≦a≦R₁
θ₂+(θ₁−θ₂)(1−(a−R₁)/(R₂−Rᵢ)) R₁<a≦R₂
θ₂(1−(a−R₂)/(R₃−R₂)) R₂<a≦R₃
0 a>R₃
For other situations that b≠1:
g(t,a,b; θ)=g(t, a/b, 1; θ)
Here, θ={θ₁, θ₂, R₁, R₂, R₃} is the parameter list, the meanings of these parameters are shown in FIG. 8.
t(k)=type of GDCS k (shopping center, office building, residential subdivision, etc.)
a(k)=accessibility scores of store i and competitors for GDCS k
b=attractiveness scores of store i and competitors

### 5. Demand Adjustment Factor (Element 104, FIG. 1)

The demand adjustment factor model adjusts the final sales contribution to a store, taking into further consideration certain discounts to said model based on attractiveness, accessibility, store clustering effect, and the probability of selection. The demand adjustment factor is represented by:

f_{c}(t,a,b;θ)=cₘₐₓ(cₜₒₜₐₗ/cₘₐₓ)^{μ}p με[0,1]

wherein:
cₘₐₓ represents the discount by attractiveness and accessibility;
(cₜₒₜₐₗ/cₘₐₓ)^{μ} represents the store clustering effect; and
p represents the probability of selection.
   The estimates for Unit Demand are then used in a Sales Prediction Module which predicts the potential sales for the new store in that certain geographical area, and optionally, predicts the impact of the new store's sales on competing stores in that certain geographical area.

### 6. Sales Prediction Module (Element 105, FIG. 1)

This module implements demand evaluation and sales prediction.

For demand evaluation, information needed includes;

Unit demand for residents: $ per person

Unit demand for office workers: $ per unit are of office space

Unit demand for shoppers: $ per $1 M sales

For sales prediction, wherein the prediction is variously for sales of new and existing stores, and can include the impact on competitors, a high resolution demand model is constructed in order to perform the demand evaluation:

$$\begin{matrix}D ( i , j , k ) = demand of store i from customers in GDCS k in grid j \\ = q ( k ) \times U ( t ( k ) ) \times {f}_{i} ( t ( k ) , a ( k ) b θ )\end{matrix}$$

### Here,

q(k)=population or sales volume of GDCS k
t(k)=type of GDCS k (shopping center, office building, residential subdivision, etc.)

$$\begin{matrix}U ( t ) = unit demand from a GDCS of type t \\ = optimization variable\end{matrix}$$

fᵢ(t,a,b, θ)=adjustment factor for store i by type, accessibility a, and attractiveness b θ is the parameter list, optimization variable
a(k)=accessibility scores of store i and competitors for GDCS k
b=attractiveness scores of store i and competitors
   U(t) and θ can be worked out by least squares;

$$\{ U ( t ) ; θ \} = arg min {\sum }_{i , j} w ( i , j ) {\{ s ( i , j ) - {\sum }_{k} D ( i , j , k ) \}}^{2}$$

While, U(t) and θ have been decided, the sales of store i can be written as:

$$S ( i ) = {\sum }_{k} q ( k ) \times U ( t ( k ) ) \times {f}_{i} ( t ( k ) , a ( k ) , b ; θ )$$

Here, fᵢ(t(k),a(k),b; θ) is the demand adjustment factor (element 104, FIG. 1).

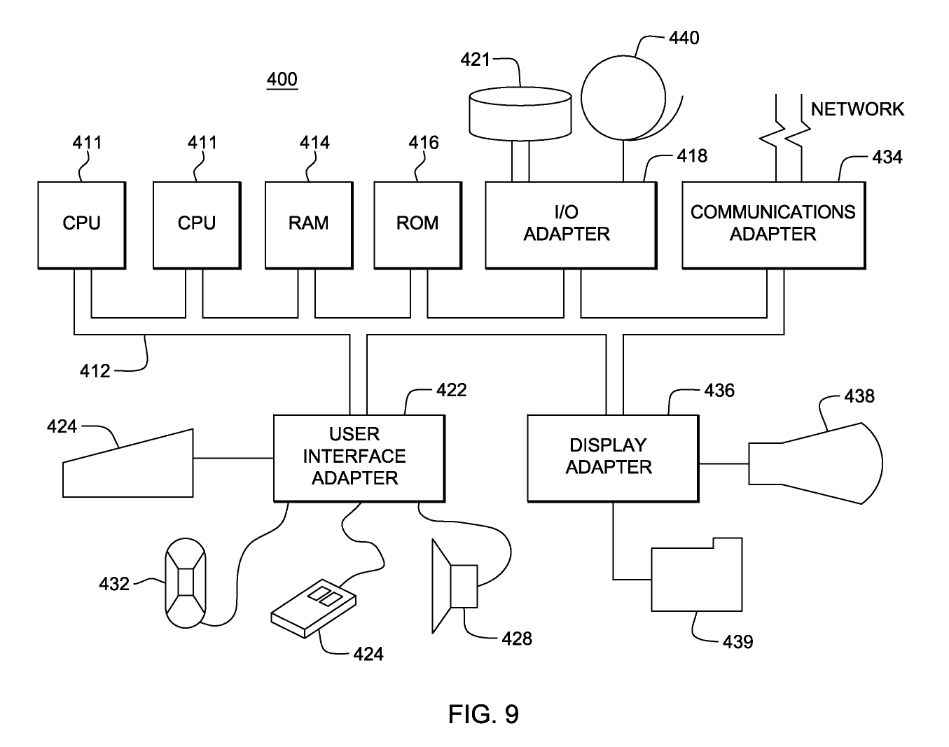

FIG. 9 illustrates an exemplary hardware configuration of a computing system 400 running and/or implementing the method steps described herein. The hardware configuration preferably has at least one processor or central processing unit (CPU) 411. The CPUs 411 are interconnected via a system bus 412 to a random access memory (RAM) 414, read-only memory (ROM) 416, input/output (I/O) adapter 418 (for connecting peripheral devices such as disk units 421 and tape drives 440 to the bus 412), user interface adapter 422 (for connecting a keyboard 424, mouse 426, speaker 428, microphone 432, and/or other user interface device to the bus 412), a communication adapter 434 for connecting the system 400 to a data processing network, the Internet, an Intranet, a local area network (LAN), etc., and a display adapter 436 for connecting the bus 412 to a display device 438 and/or printer 439 (e.g., a digital printer of the like).

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with a system, apparatus, or device running an instruction.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with a system, apparatus, or device running an instruction. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may run entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations (e.g., FIG. 1) and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which run via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which run on the computer or other programmable apparatus provide processes for implementing the functions/acts specified in the flowchart and/or block diagram block or blocks.

The block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more operable instructions for implementing the specified logical function(s). It should also be noted that, in some alternative implementations, the functions noted in the block may occur out of the order noted in the figures. For example, two blocks shown in succession may, in fact, be run substantially concurrently, or the blocks may sometimes be run in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although an illustrative embodiment of the present invention has been described herein with reference to the accompanying drawings, it is understood that the invention is not limited to the illustrative embodiment and that various other changes and modifications may be made by one of skill in the art without departing from the scope of the invention.

What is claimed is:

1. A method of predicting sales for a new retail store to be located in a certain geographical area comprising:
a) identifying at least one customer segment in the certain geographic area associated with the new retail store;
b) generating a Consumer Demand Estimation Module for the new retail store comprising
(i) an Accessibility Model;
(ii) an Attractiveness Model;
(iii) a Customer Preference Model; and
(iv) a Demand Adjustment Factor; and
c) obtaining a Unit Demand for each customer segment from the Consumer Demand Estimation Module; and
d) providing the Unit Demand to a Sales Prediction Model that generates a prediction of sales for the new retail store.

2. The method of claim 1 wherein the customer segment includes any or all of the following in the certain geographical area: residents, workers, shoppers.

3. The method of claim 1 wherein the Accessibility Model generates an accessibility score for the new retail store in the certain geographical area, the accessibility score based on information comprising road connectivity, topology of geographic road segments, cross roads, over passes, bridges, road direction, means of transportation, cost of transportation, the accessibility score being used to select the most probable route to the new store from a given customer segment.

4. The method of claim 1 wherein the Attractiveness Model generates an attractiveness score for the new retail store in the certain geographical area, the Attractiveness Model comprising a quantitative closed-loop feedback mechanism to adjust the attractiveness score, the attractiveness score based on information comprising store sales, store attribute data, and on-site shopper survey data.

5. The method of claim 4 wherein the store attribute data comprises store visibility, store size, store service level, store environment.

6. The method of claim 4 wherein the on-site shopper survey data comprises shopper feedback on store attractiveness.

7. The method of claim 1 wherein the Customer Preference Model comprises estimating the probability of selection by a particular customer segment to select a competing store over the new retail store in the certain geographical area based on the difference between the attractiveness and accessibility of the competing store and the new store.

8. The method of claim 1 wherein the Demand Adjustment Factor adjusts the final sales contribution to a store by discounting the store's attractiveness, accessibility, store clustering effect, and probability of selection.

9. A computer-based method to predict sales for a new convenience retail outlet in a certain geographic area, comprising:
a) segmenting customers in the certain geographic area into Geographically Distributed Customer Segments (GDCS), the GDCS being selected from any or all of the following:
(i) residents in said geographic area
(ii) workers in said geographic area
(iii) shoppers in said geographic area
b) storing the GDCS in a Geographic Information System (GIS) platform;
c) dividing the certain geographical area into a grid system;
d) identifying at least one existing store in the grid system and obtaining customer information for the store, the customer information comprising sales attributable to a given customer in the existing store and the identification of the GDCS to which the given customer belongs;
e) providing an accessibility score from each GDCS in the certain geographical area to the new store and to at least one competing store in the certain geographical area, the accessibility score comprising information on road connectivity from each GDCS to the new store and to the at least one competing store, condition of the road connectivity, means of transportation from each GDCS to the new store and the at least one competing store, and cost of the means of transportation;
f) providing an attractiveness score for the new store and for at least one competing store in the geographical area, the attractiveness score comprising attractiveness information on the new store and the at least one competing store in the certain geographical area, the attractiveness information comprising: visibility of the new store and the at least one competing store, size of the new store and the at least one competing store, service level at the new store and the at least one competing store, environment of the new store and the at least one competing store, and on-site shopper survey data on attractiveness at the new store and the at least one competing store;
g) generating a customer preference estimate, the customer preference estimate comprising the probability that a particular GDCS will select the new store and the at least one competing store;
h) generating a demand adjustment factor based on the accessibility score, the attractiveness score and the customer preference estimate; and
i) predicting the sales of the new store using the demand adjustment factor.
